(19) United States
(12) Patent Application Publication
(10) Pub. No.: US 2009/0213778 A1
(43) Pub. Date: Aug. 27, 2009

(54) Fragmentation and Packing for Wireless Multi-User Multi-Hop Relay Networks

(76) Inventors: Zhifeng Tao, Allston, MA (US); Jinyun Zhang, Cambridge, MA (US)

Correspondence Address: MITSUBISHI ELECTRIC RESEARCH LABORATORIES, INC., 201 BROADWAY, 8TH FLOOR, CAMBRIDGE, MA, 02139, US

(21) Appl. No.: 12/203,319

(22) Filed: Sep. 3, 2008

Related U.S. Application Data
(60) Provisional application No. 61/020,894, filed on Jan. 14, 2008.

(51) Int. Cl. H04B 7/14

(52) U.S. Cl. 370/315

(57) ABSTRACT

A hop-by-hop and multi-hop approach for fragmentation and packing are provided for a wireless multi-hop relay network. The fragmentation and packing operate at ingress, intermediate, and egress stations of a tunnel connecting a base station (BS) with an access relay station (RS). A format of the associated relay fragmentation and packing subheader are specified. In addition, a tunnel data includes numbered blocks to ensure correct packet sequencing for proper packet construction and reassembly for fragmentation and packing in the multi-hop relay network.

### RELATED APPLICATION

This Application claims priority to U.S. Provisional Patent Application 61/020,894, “Fragmentation and Packing for Multihop Relay Network,” filed by Tao et al. on Jan. 14, 2008, which is incorporated herein in its entirety for all purposes.

### FIELD OF THE INVENTION

This invention relates generally to wireless mobile networks, and more particularly to fragmentation and packing in wireless multi-user, multi-hop relay networks.

### BACKGROUND OF THE INVENTION

Orthogonal frequency-division multiplexing (OFDM) is a modulation technique used at the physical layer (PHY) of a number of wireless networks, e.g., networks designed according to the IEEE 802.11a/g, and IEEE 802.16/16e standards. OFDMA is a multiple access scheme based on OFDM. In OFDMA, separate sets of orthogonal tones (subchannels) and time slots are allocated to multiple transceivers (users) so that the transceivers can communicate concurrently. As an example, the IEEE 802.16/16e standard, has adopted OFDMA as the multiple channel access mechanism for non-line-of-sight (NLOS) communications at frequencies below 11 GHz.

FIG. 1A shows a conventional OFDMA-based cellular network 100, e.g., a wireless network according to the IEEE 802.16/16e standard, incorporated herein by reference. The network confines operations to a point-to-multipoint topology, wherein only two types of network entity exist, namely base stations (BS), and mobile stations (MS). Each station includes a transmitter and a receiver, i.e., a transceiver.

The BS manages and coordinates all communications with the MS in a particular cell on connections (wireless channels) 101-103. Each MS is in direct communication with only the BS, and only the BS communicates with an infrastructure 110 or “backbone” of the network. That is, there is only one hop between the MS and the BS. All communications between the MS must pass through the BS. Furthermore, there is only one connection between the BS and each MS.

Due to significant loss of signal strength along the connection for certain spectrum, the coverage area of wireless service is often of limited geographical size. In addition, blocking and random fading frequently results in areas of poor reception, or even dead spots. Conventionally, this problem has been addressed by deploying BSs in a denser manner. However, the high cost of BSs and potential increase in interference, among others, render this approach less desirable.

As shown in FIG. 1B for an alternative approach, a relay-based network 150 can be used. The network includes multiple mobile stations (MS) and/or subscriber stations (SS). A relatively low-cost relay station RS extends the range of the BS. Some of the stations (MS1 and SS1) communicate directly with the BS using connections C1 and C2. Other stations (MS2, MS3 and SS2) communicate directly with the RS using connections C3, C4 and C5, and indirectly with the BS via corresponding connections 151 using two hops. Obviously, communications on the link between the RS and BS (relay link) can become a bottleneck.

In order to effectively address this issue on relay link, tunneling can be used, see U.S. Patent Application 20080107061, “Communicating packets in a wireless multi-user multi-hop relay networks,” filed by Tao et al. on May 8, 2008, and incorporated herein by reference.

As shown in FIG. 2, a tunnel 210 is a wireless connection established between a multi-hop base station (MR-BS) and an access RS (RS3) to transport packets generated by or destined to various MSs (MS3, MS4, and MS5) associated with the access RS. For clarity, ingress and egress stations are defined for the tunnel. The ingress station is a first station at a first end of the tunnel, and the egress station is a last station at a second end of the tunnel.

Specifically for the uplink, the access RS (RS3) is the ingress station, and the BS is the egress station. For the downlink, the BS is the ingress station, and the access RS (RS3) is the egress station. For both downlink and uplink transmission, RSs on the relay path between the ingress and egress stations (RS1, RS2) are called intermediate stations in the case that the RS3 is the access RS.

The access RS is the RS to which a MS is directly connected. Thus, RS3 is the access RS for MS 3-MS5, RS2 is the access RS for MS2, and RS1 is the access RS for MS 1.

The relay link utilization efficiency can be improved to meet the demanding throughput and QoS requirement on relay links, by using such conventional techniques as fragmentation and packing.

FIG. 3 shows the packing according the conventional IEEE 802.16 standard. The fields shown are described in detail in the IEEE 802.16 standard.

However, the packing and fragmentation protocol specified in the conventional IEEE 802.16 standard was designed for single-hop network, and thus may result in sub-optimal performance and limit the overall network capacity, if it is applied in a relay network as shown in FIG. 1B.

As a result, more efficient fragmentation and packing is desired for multi-hop relay networks.

### SUMMARY OF THE INVENTION

The embodiments of the invention provide a hop-by-hop and multi-hop method for fragmentation and packing in a wireless multi-hop relay network. The fragmentation and packing operate at ingress, intermediate, and egress stations of a tunnel connecting a base station (BS) with an access relay station (RS).

A format of the associated relay fragmentation and packing subheader are defined. In addition, the embodiments of the invention also define a tunnel data unit, and provide a mechanism to ensure correct packet sequencing, both of which are needed for proper packet construction and reassembly for fragmentation and packing in multi-hop relay networks.

### BRIEF DESCRIPTION OF THE DRAWINGS

FIG. 1A is a schematic of a prior art wireless mobile networks;

FIG. 1B is a schematic of a prior art wireless mobile relay network;

FIG. 2 is a schematic of a prior art wireless mobile relay network with tunnel connection;

FIG. 3 is a schematic of a packing operation and generic MAC header (GMH) defined according to the conventional IEEE 802.16 standard;

FIGS. 4A-4C are schematics of packing and fragmentation defined according to the conventional IEEE 802.16 standard;

FIG. 5 is a schematic of hop-by-hop fragmentation and packing in a multi-hop relay network according to embodiments of the invention;

FIG. 6 is a schematic of multi-hop fragmentation and packing in a multi-hop relay network according embodiments of the invention;

FIGS. 7A-7B are schematics of tunnel data units according to embodiments of the invention;

FIG. 8 is a schematic of fragmentation and packing at an ingress station according to embodiments of the invention;

FIG. 9 is a block diagram of a relay fragmentation subheader according to embodiments of the invention;

FIG. 10 is a block diagram of a relay packing subheader according to embodiments of the invention;

FIG. 11 is a schematic of fragmentation and packing at an ingress station with end-to-end sequencing capability according to embodiments of this invention;

FIG. 12 is a schematic of a problem encountered at intermediate station in a multi-hop approach without end-to-end sequencing;

FIG. 13 is a schematic of fragmentation and packing at intermediate station when end-to-end sequencing according to embodiments of the invention; and

FIG. 14 is a schematic of fragmentation and packing at an egress station according to embodiments of the invention.

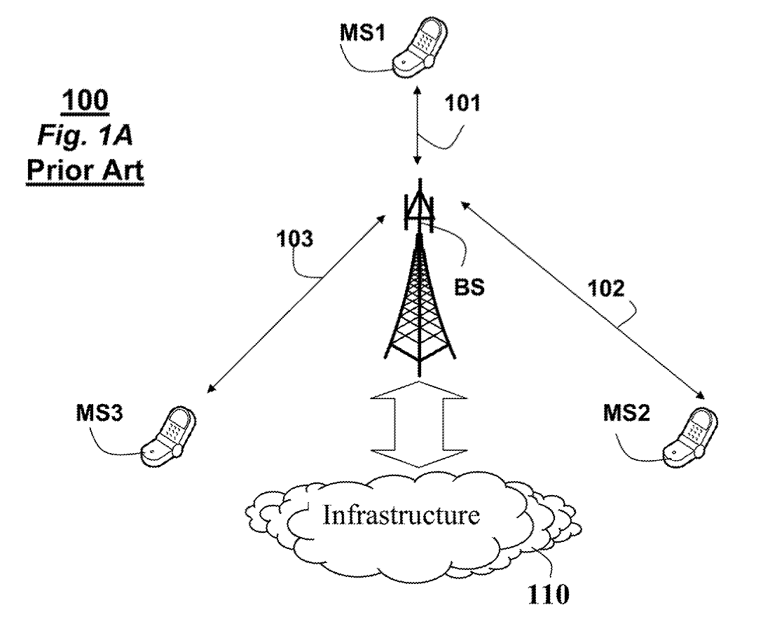

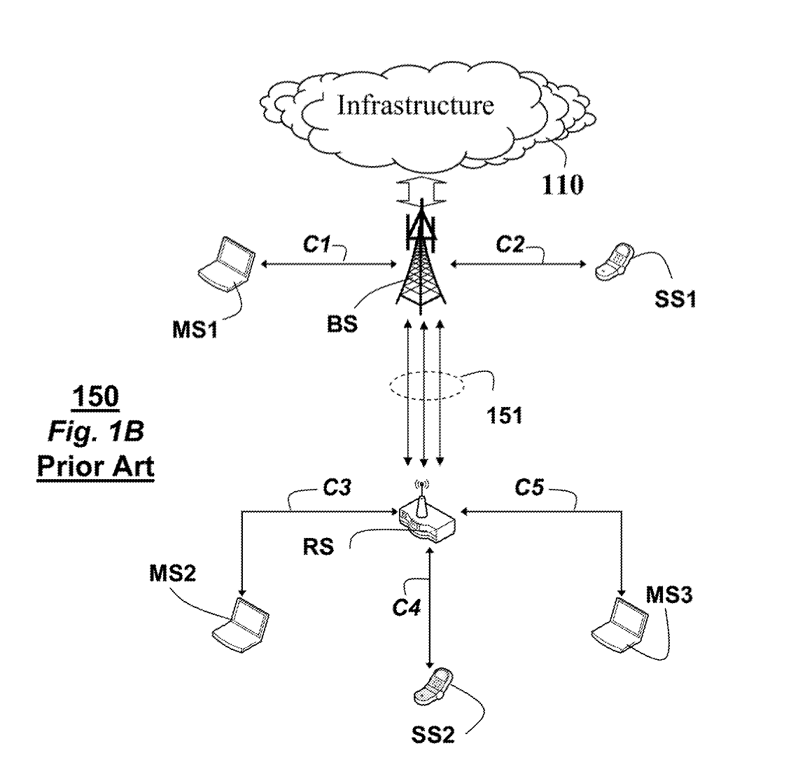

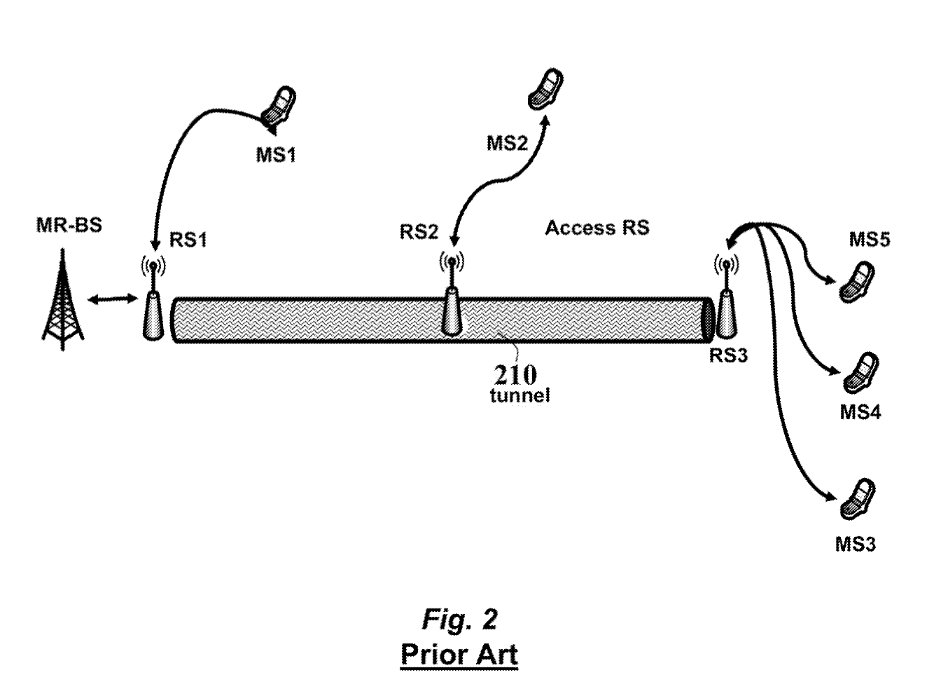

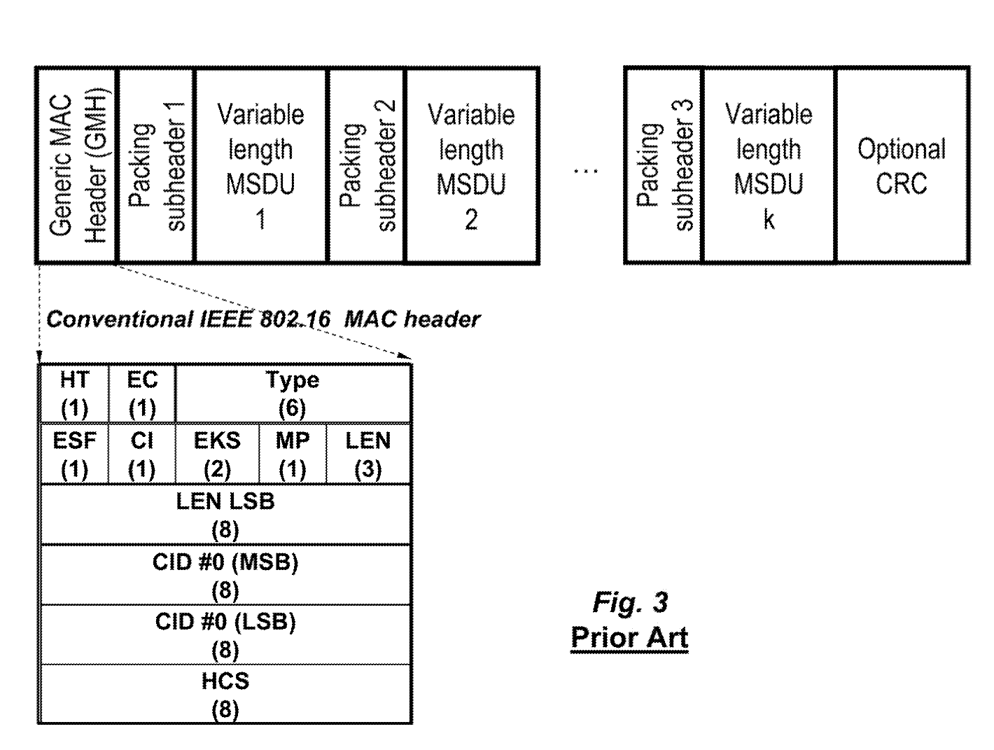

### DETAILED DESCRIPTION OF THE PREFERRED EMBODIMENTS

Definitions

The following terms are defined and used herein.

Base Station (BS)

Equipment to provide wireless communication between subscriber equipment and an infrastructure or network backbone.

Subscriber Station (SS)

A generalized equipment set to provide communication between the subscriber equipment and the base station (BS).

Mobile Station (MS)

A wireless transceiver intended to be used while in motion or at unspecified locations. The MS is always a subscriber station (SS) unless specifically specified otherwise.

Relay Station (RS)

A wireless transceiver for relaying data and control information between other stations, and to execute processes that support multi-hop communications.

As know in the art, each station includes a transmitter and a receiver. The stations can also include one or more antennas.

Connection

At a physical layer, a connection runs from an RF transmitter of a station via one or more transmit antennas through a wireless channel to an RF receiver of another station via one or more receive antennas. Physically, the communicates RF signals using a predetermined set of subchannels and time slots.

At a logical layer, the portion of interest of the connection runs from a media access layer (MAC) of a protocol stack in the transmitter to the media access layer in the receiver. Logically, the connection caries data and control information as a single bit stream.

MAC Service Data Unit (MSDU)

A set of data specified in a protocol of a given layer and including of protocol control information of that layer, and possibly user data of that layer.

MAC Protocol Data Unit (MPDU)

A protocol data unit of a given layer of a protocol including the service data unit coming from a higher layer and the protocol control information of that layer. A burst is a sequence of contiguous MPDUs that belong to the same connection.

Packing and Fragmentation in Conventional IEEE 802.16

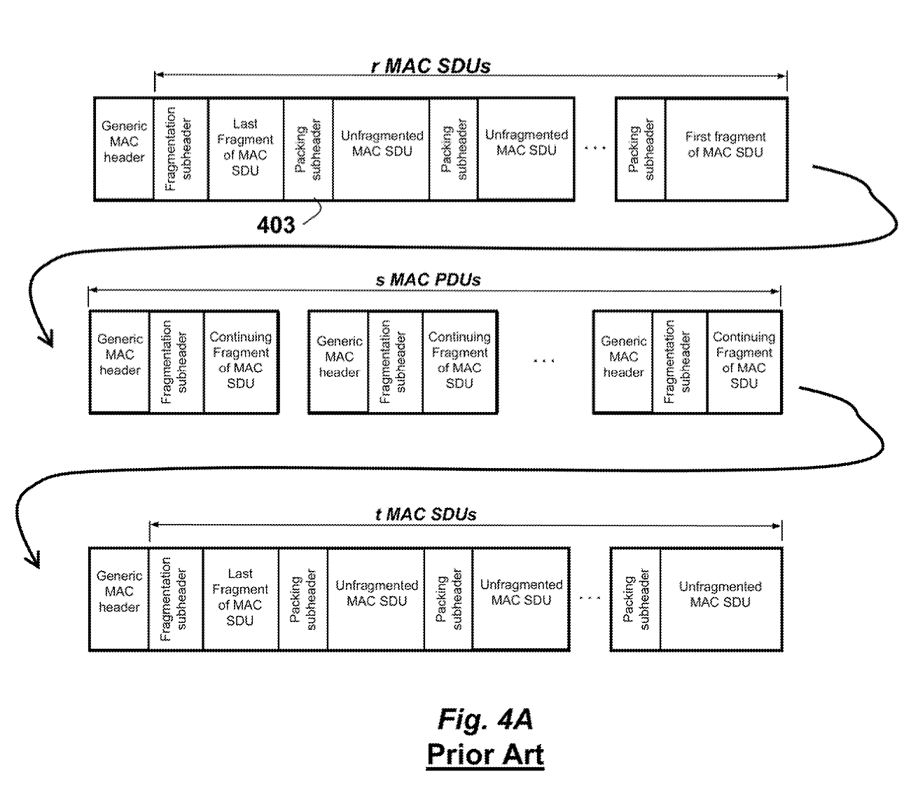

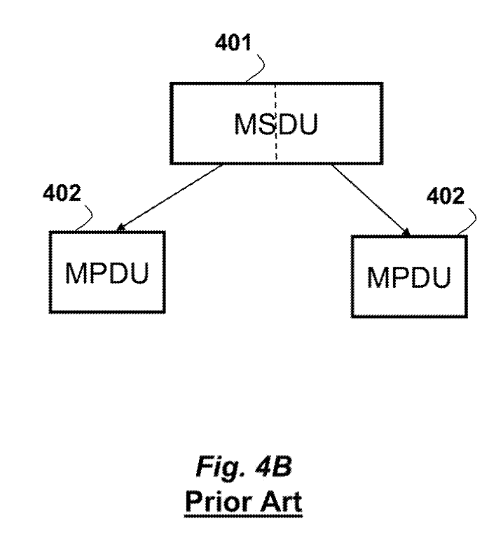

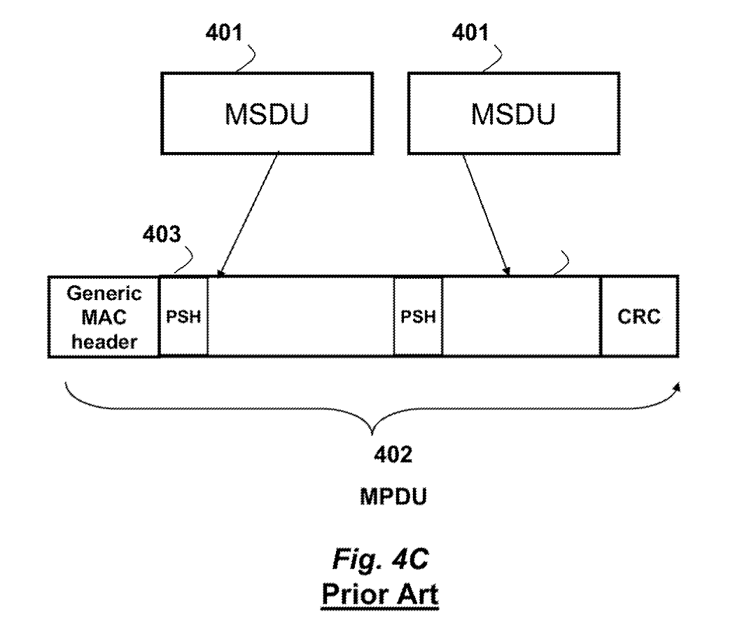

As shown in FIG. 4A packing and fragmentation are two complimentary techniques that are used in many wireless communications systems to improve the efficiency of the link capacity utilization.

Fragmentation

As shown in FIG. 4B, fragmentation is the process by which a single MSDU 401 is partitioned (fragmented) into multiple MPDUs 402. It is used when the transmitter has at least one MPDU to send, but the wireless resource allocated to the transmitter is insufficient to transmit the entire MPDU in one burst.

Without fragmentation, the transmitter would normally have to stay idle until a future resource allocation is adequate for transmitting the MPDU in one burst.

With fragmentation, the smaller MPDU fragments can be sent immediately using the otherwise limited resource. Although fragmentation incurs some protocol overhead, it is more efficient than simply staying idle on the allotted precious wireless channel resource.

Packing

As shown in FIG. 4C, the packing protocol defined in the conventional IEEE 802.16 concatenates multiple MSDUs 401 of variable length into one MPDU 402, and delimits the MSDUs using a packing subheader (PSH) 403. The PSH contains the length and sequence number of the MSDU that immediately follows. Because each MPDU contains only one MAC header and one cyclic redundancy check (CRC) as shown in FIG. 4A, the packing reduces the number of MPDUs generated, thereby lowering the overhead of the protocol incurred by MAC header and CRC.

FIG. 4A shows fragmentation and packing used concurrently on a wireless link. Concurrent fragmentation and packing enables efficient use of the channel, but requires guidelines to be followed so it is clear which MAC SDU is currently in the state of fragmentation. More specifically, the conventional IEEE 802.16 specifies that when the PSH is present, the fragmentation information for individual MAC SDUs or MAC SDU fragments is contained in the corresponding PSH.

If no PSH is present, the fragmentation information for individual MSDU fragments is contained in the corresponding fragmentation subheader (FSH).

Packing and Fragmentation in Multi-hop Relay Network

Fragmentation and packing in a multi-hop relay network can be performed either on a per-hop basis, or on a multi-hop basis.

Per-Hop

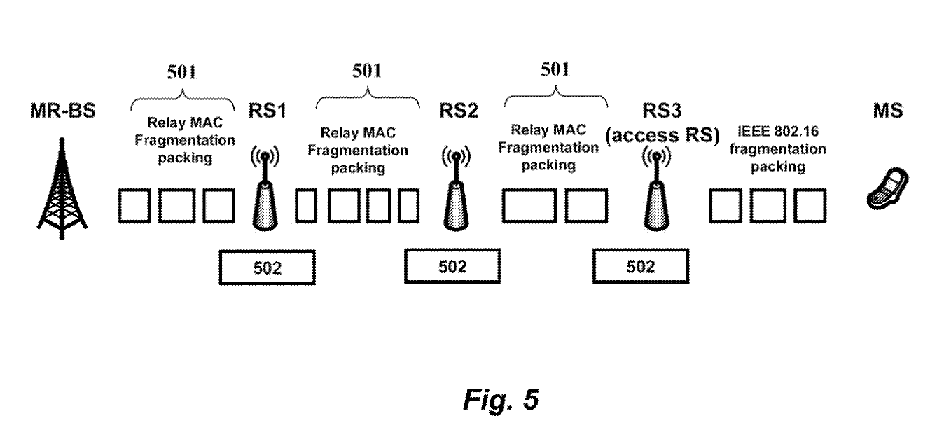

As shown in FIG. 5, fragmentation and packing can be completed on a per-hop basis. Each RS re-assembles the relay MAC PDU fragments 501 received from the previous hop into a single data unit 502, before the RS further performs fragmentation on the data unit for the next hop. In this case, the fragmentation or packing scheme in the conventional IEEE 802.16 standard can be directly applied On relay MAC PDU on each relay hop. When tunnel is used, the per-hop fragmentation and packing is applied on the relay MAC PDU, instead of IEEE 802.16 MAC PDU.

The per-hop solution approach is valid for both centralized security and distributed security defined in the conventional IEEE 802.16j draft standard. The centralized security defines a security session directly between the MR-BS and the MS, and the access RS does not have an encryption key. In the distributed security, the access RS has the encryption key and can decrypt the traffic between the MR-BS and the MS.

The constraint that an intermediate RS between the access RS and the MR-BS cannot forward the fragment unless the RS successfully assembles all the related fragments of the original relay MAC PDU that its superordinate RS (in downlink case) or subordinate RS (in uplink case) sends may potentially be a major drawback. Such a constraint would make it necessary to have extra buffering, and thus incur additional delay.

Multi-Hop

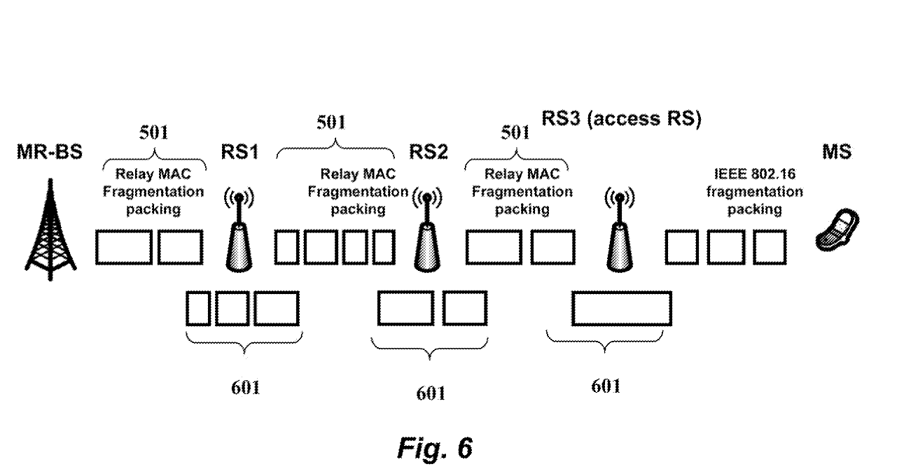

As shown in FIG. 6, fragmentation and packing can be completed on a multi-hop basis. Each intermediate RS can further fragment or pack 601 relay MAC PDU fragments received from its superordinate station or subordinate without having to successfully complete the reassembly.

The multi-hop approach does not necessarily mean that the reassembly 601 does not occur at all until reaching MR-BS (uplink case) or the access RS (downlink case). In multi-hop approach, if there is bandwidth available, the RS does not need to wait until it receives all the fragments of an original relay MAC PDU, before the RS performs further fragmentation/packing and forward the traffic to the next hop.

However, if there is any error in any received fragment, the RS drops that fragment, if no automatic repeat-request (ARQ) is performed, and the successful delivery of rest of the fragments is not possible. In fact, forwarding the rest of the fragments in this case wastes relay link bandwidth, in case no ARQ is used.

Tunnel Data Unit

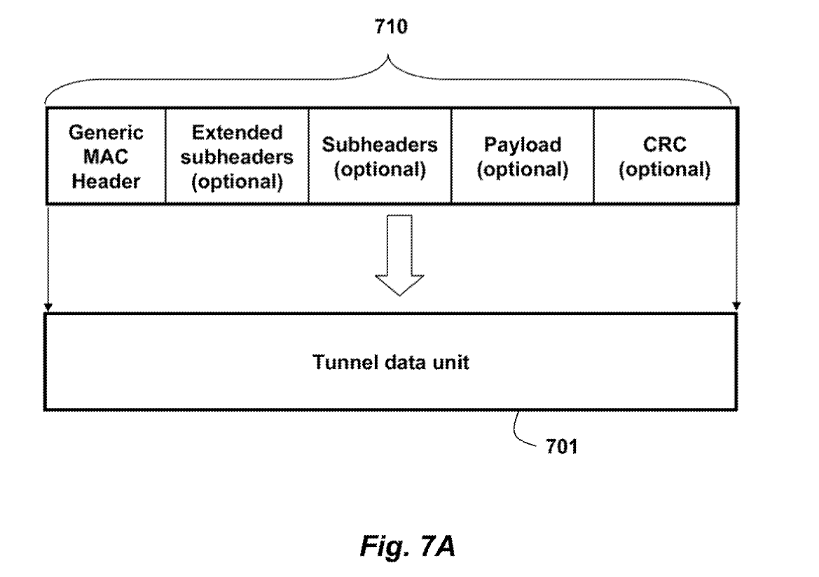

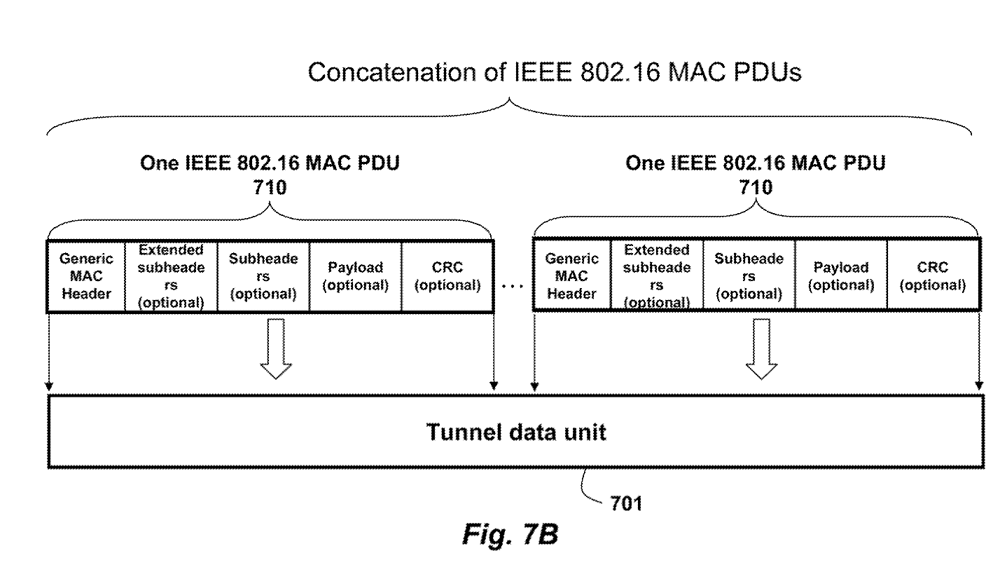

As shown in FIGS. 7A-7B, a tunnel data unit 701 includes one or more MPDUs. The tunnel data unit is constructed from one or more MPDUs at the ingress station of a tunnel. The one or more MPDUs are reconstructed at the egress station. The intermediate stations can apply such operation as fragmentation/reassembly and packing on the tunnel data unit.

As defined herein, and as described in U.S. Patent Application 20080107061, a logical “mega-pipe,” that is the tunnel 210, is established between the access relay station and the mobile-relay base station (MR-BS) to transport traffic aggregated from multiple different individual connections. These individual connections to be aggregated can originate from different mobile stations, and share some common characteristics, e.g., a quality of service (QoS) requirement.

The establishment, maintenance and identification of such the tunnel is optimized so that the efficiency at data plane is substantially improved while the associated overhead in the control plane is minimized, thereby enabling IEEE 802.16j MMR network to deliver a superior performance.

We separately describe operations on the tunnel data unit at the ingress RS, the intermediate RS, and the egress RS.

Ingress Station

The steps described below are followed by both the per-hop and the multi-hop approaches at the ingress station of the tunnel to prepare relay MAC PDU using IEEE 802.16 standard MAC PDUs.

Constructing a Tunnel Data Unit

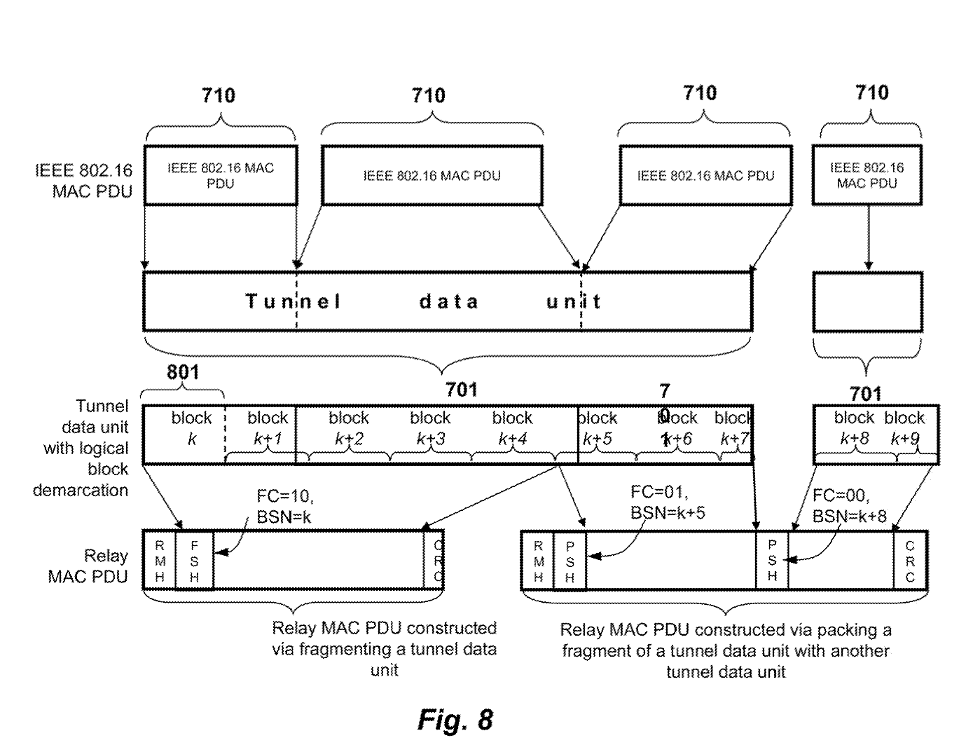

The tunnel data unit 701 is shown in FIGS. 7A-7B. FIG. 7A shows the tunnel data unit for one MPDU 710, and FIG. 7B for multiple concatenated MPDUs 710. For the purpose of constructing the tunnel data unit as shown in FIG. 8, the MPDUs are partitioned into logical blocks 801, and logical sequence numbers k are assigned to the blocks.

Note that the block boundaries as defined for the tunnel data unit do not need to be aligned with the boundaries of the MPDUs as in the prior art. That is a single logical block can extend across two consecutive tunnel data units. Furthermore, fragmentation can be applied for the tunnel data unit 701 at, or between block boundaries.

Logically Partition the Generated Tunnel Data Unit into Blocks

The block size for the blocks in the tunnel data unit is negotiated between the ingress and egress station of the tunnel when the tunnel is established. If a length of the tunnel data unit cannot be partitioned by the block size, the size of the last logical tunnel block in a particular tunnel data unit can be shorter than the negotiated block size.

Fragment and Pack Tunnel Data Unit, and Generate Relay MPDU

FIG. 8 shows the construction of the tunnel data unit for the relay MAC PDU at the ingress station. The format of the fragmentation subheader and packing subheader are similar to the conventional IEEE 802.16 standard. However, because the tunnel usually spans multiple hops a larger sequence number is used to avoid wrap-around of the sequence number.

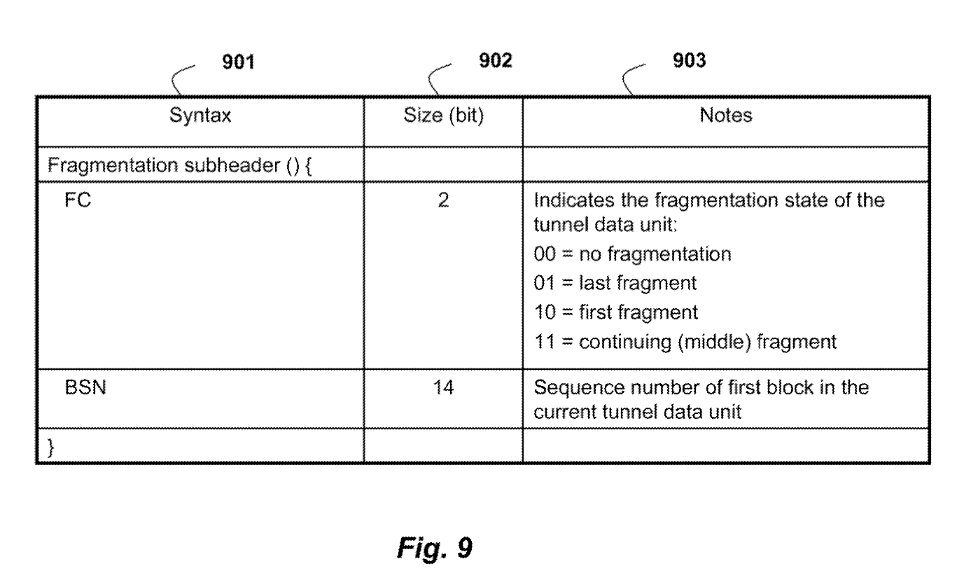

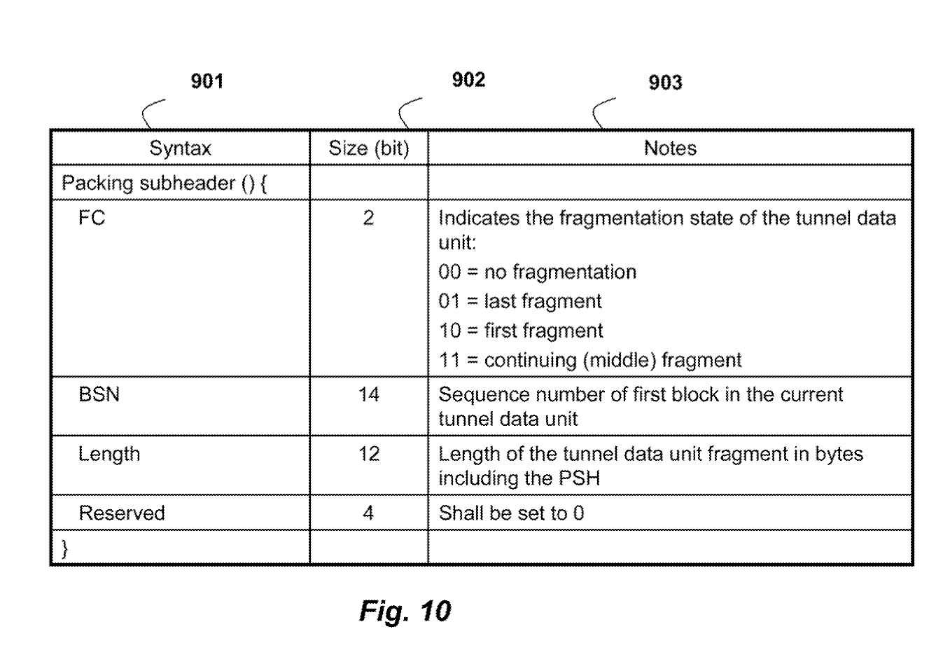

Instead of using the 11-bit block sequence number as defined in the conventional IEEE 802.16 standard, we use a 14-bit block sequence number. As a result, the fragmentation subheader (FSH) and the packing subheader (PSH) assume the formats as shown in FIG. 9 and FIG. 10, respectively. The columns in the tables are syntax 901, size 902 and notes 903. The rows in the table correspond to the respective fields in the headers.

Note that the “Length” field in PSH now is 12 bits long, because the tunnel data unit can be as large as 2048 bytes.

The peculiarities of fragmentation and packing in per-hop approach and multi-hop approach at ingress RS is described below.

Operation for Per-Hop Approach at Ingress Station

The fragmentation and packing subheaders are as defined in the IEEE 802.16 standard.

Operation for Multi-Hop Approach at Ingress Station

Without End-to-End Sequencing

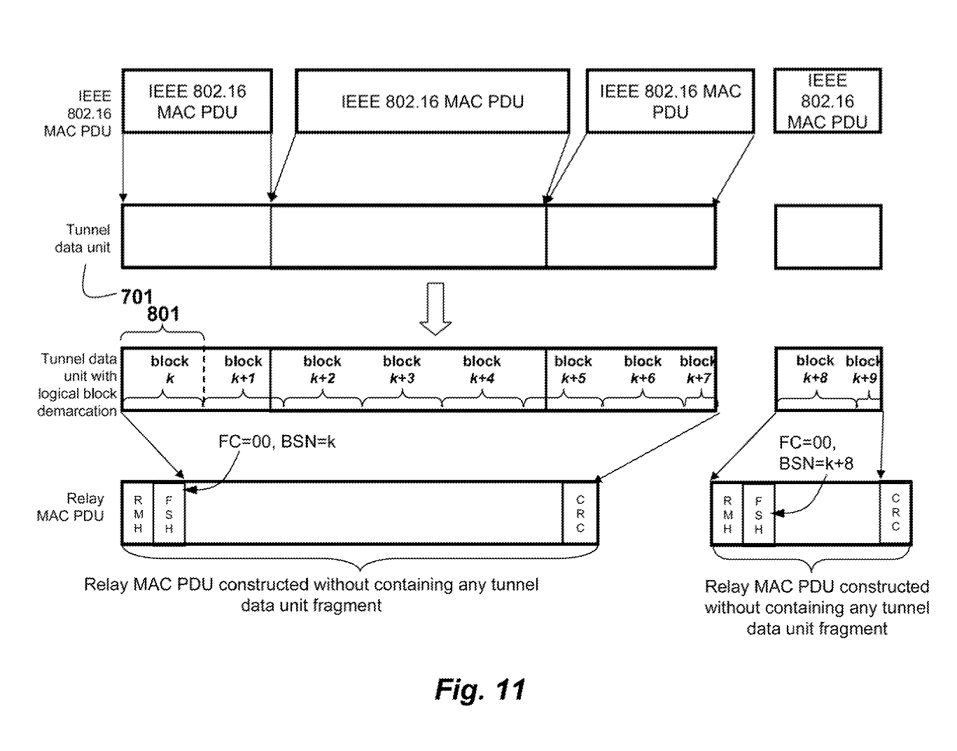

When no end-to-end sequencing is required as shown in FIG. 11, a relay MAC PDU includes a relay MAC header (RMH), extended relay subheaders (optional), relay subheaders (optional), one of the following four payloads, and an optional relay CRC.

The payloads can be:
a tunnel data unit;
a fragmentation subheader (FSH) and a fragment of a tunnel data unit;
a packing subheader (PSH) and a fragment of a tunnel data unit and
one or more pairs of packing subheader and tunnel data unit and zero or one pair of packing subheader, and
a fragment of another tunnel data unit;
a packing subheader and a fragment of a tunnel data unit and
a packing subheader and a fragment of another tunnel data unit.

With End-to-End Sequencing

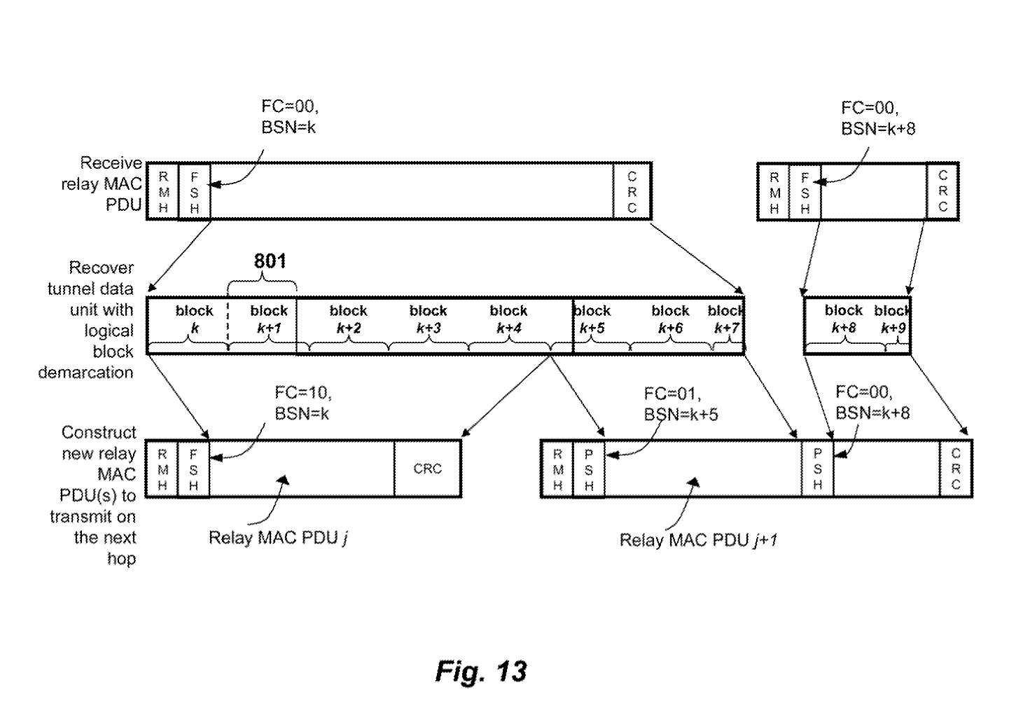

When sequential data delivery is desired, we provide end-to-end sequencing as shown in FIG. 13. This ensures that the block sequence number of the first logic block of the tunnel data unit is always explicitly carried in the relay MAC PDU.

Specifically, the ingress RS inserts a fragmentation subheader in the relay MAC PDU, even if the relay MAC PDU does not include a tunnel data unit fragment. In this case, the relay MAC PDU includes a relay MAC header, extended relay subheaders (optional), relay subheaders (optional), one of the following four payloads, and an optional relay CRC.

The payloads can be:
a fragmentation subheader (FSH ) and a tunnel data unit;
a fragmentation subheader (FSH) and a fragment of a tunnel data unit;
a packing subheader (PSH), a fragment of a tunnel data unit, one or more pairs of a packing subheader and tunnel data unit, zero or one pair of packing subheader, and another tunnel data unit fragment;
a packing subheader and a fragment of a tunnel data unit; and
subheader and a fragment of another tunnel data unit.

Even if no fragmentation or packing occurs on the tunnel data unit carried by the relay MAC PDU, the fragmentation subheader is still forwarded together with the tunnel data unit by all the intermediate RSs. However, because fragmentation subheader is only 2 bytes long, while the relay MAC PDU usually is longer, the overhead incurred by ensuring orderly data delivery is not significant and justifiable.

Intermediate Station
Operation for Per-Hop Approach at Intermediate Station

Because the ARQ is performed in an end-to-end manner between the MR-BS and an MS, no retransmission mechanism is enforced at any RS. Thus, the relay MAC PDU fragments are transmitted one time, and in sequence. The block sequence number assigned to each fragment enables the receiving intermediate RS to regenerate the original tunnel data unit and to detect the loss of any fragment belonging to a single tunnel data unit.

Upon a loss of data, the receiving intermediate RS discards all the fragments that belong to the same tunnel data unit until a new first fragment is detected or a non-fragmented tunnel data unit is detected.

A timer can be started after a receiving intermediate RS detects a new first fragment. If the timer expires before the receiving intermediate RS receives all the needed fragments successfully to reassemble the original tunnel data unit, then the RS discards all the fragments belonging to this tunnel data unit, regardless of whether each such fragment has been successfully received or not. Any receiving intermediate RS does not forward the received fragment, before the RS can successfully regenerate the original tunnel data unit.

After the tunnel data unit is successfully regenerated, the intermediate RS can forward this tunnel data unit to the next hop. Fragmentation and packing can be applied, whenever necessary, and the procedure specified for per-hop approach operation at ingress station is followed.

Operation for Multi-Hop Approach at Intermediate Station

Without End-to-End Sequencing

If no end-to-end sequencing is enforced, then the multi-hop approach does not work when there are multiple relay hops. That is, the multi-hop approach only works without end-to-end sequencing if the access relay is immediately adjacent to the MR-BS, and there is no intermediate RS on the relay path.

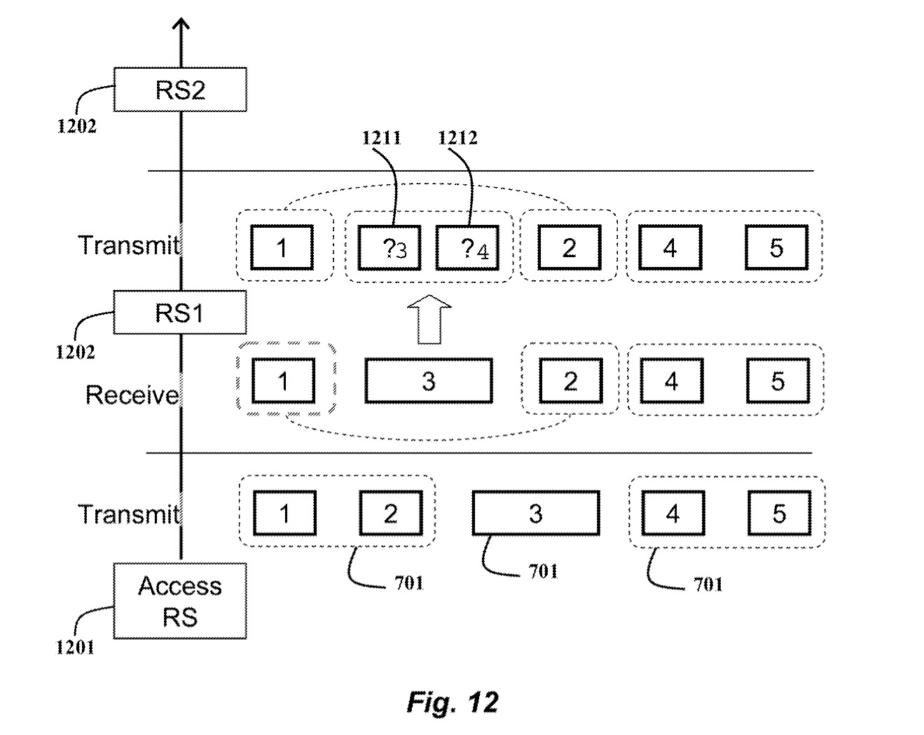

FIG. 12 shows why the multi-hop approach does not work. FIG. 12 shows the access RS, and two intermediate RS 1202. The access RS transmits five relay MAC PDUs (1, 2, 3, 4, 5) to the RS1, which is the superordindate RS for the access RS in the uplink.

The relay MAC PDU 1 and 2 are two fragments that comprise one tunnel data unit. Similarly, relay MAC PDU 4 and 5 are two fragments that comprise one tunnel data unit 701. The relay MAC PDU 3 is in a separate tunnel data unit. The access RS transmits the five relay MAC PDUs in the correct order. However, due to for any of a number of reasons, e.g., channel error, HARQ, etc, the RS1 may receive these five relay MAC PDUs in a different order then they were transmitted. For example, the RS1 may receive relay MAC PDU 1, relay MAC PDU 3, and then relay MAC PDU 2.

The RS1 may want to further fragment the tunnel data unit that includes the relay MAC PDU 3 into two separate relay MAC PDUs 1211 and 1212. However, the RS1 cannot assign the correct block sequence numbers to these two fragments.

Specifically, if the RS I follows the block sequence number assigned by its subordinate RS on the uplink transmission, or superordinate RS on the downlink transmission, it has difficulty determining the block sequence number to be assigned to these two new fragments.

The RS1 knows that the relay MAC PDU 3 is out of order, as the block sequence number indicated in relay MAC PDU 1 and 2 are consecutive. However, the RS1 cannot be sure the exact block sequence number the access RS has assigned to the relay MAC PDU 3, because the relay MAC PDU 3 is an out of order PDU. For example, if the RS1 assign number 3 and 4 to the two fragments generated from relay MAC PDU 3, this will confuse the RS2, which is the superordinate RS of RS1 on the uplink.

The RS1 can also not reassigns block sequence number of local significance to every relay MAC PDU it receives from access RS. This would lose the fragmentation information and render the fragments unable to be re-assembled at the destination.

With End-to-End Sequencing

When end-to-end sequencing is enforced, each relay MAC PDU generated by the ingress station has explicitly includes a block sequence number of the first logical block of the tunnel data unit carried by this relay MAC PDU. This block sequence number maintains a proper sequencing of the flow of tunnel data unit belonging to this tunnel.

Upon reception, the intermediate RS knows the block sequence number of the first logical block of the tunnel data unit contained in the received relay MAC PDU. Thus, the RS is able to perform further fragmentation or packing, as long as the RS follows the same sequence ordering indicated in the received tunnel data unit.

FIG. 13 shows an example of the relay MAC PDU processing and construction process. As shown, the next hop intermediate RS can forward the relay MAC PDUj, without waiting for the arrival of relay MAC PDU j+1. In fact, the next hop relay MAC PDU can even further fragment relay MAC PDUj, if needed. This is all because the egress station can still restore the order of received relay MAC PDUs based upon the block sequence number included in each relay MAC PDU.

Egress Station MPDU Reconstruction

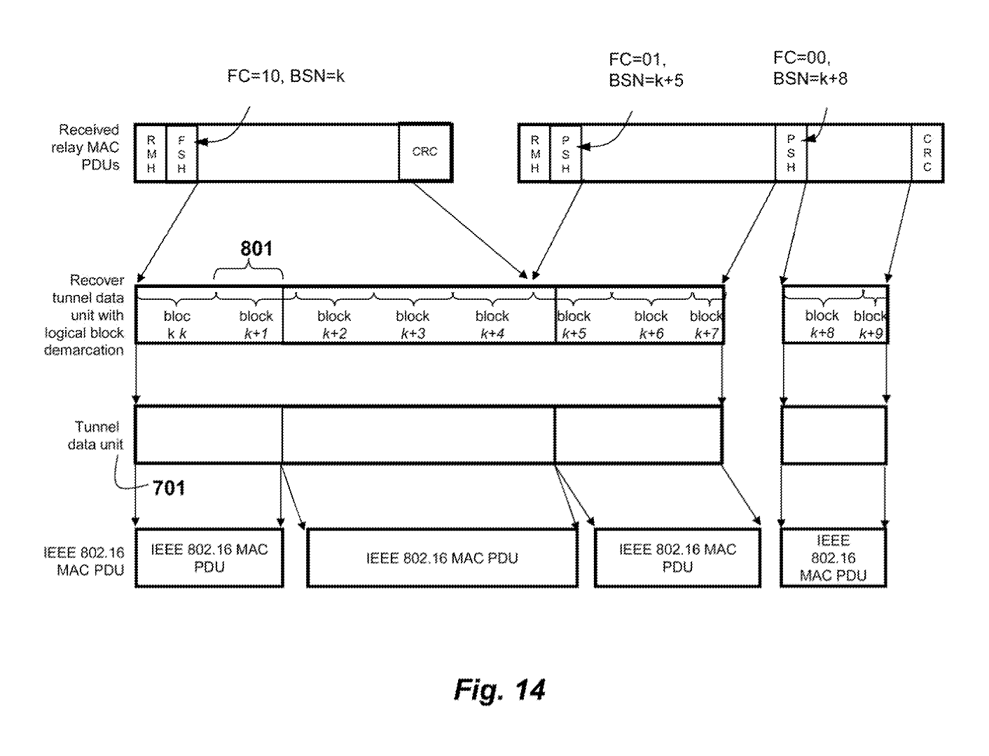

As shown in FIG. 14, the egress station reconstructs MPDUs from the tunnel data unit 701.

Operation of Per-Hop Approach at an Egress Station

FIG. 14 shows the operation at egress station. The egress station removes all the relay MAC headers, relay MAC subheaders, relay MAC extended subheaders and relay CRC from the relay MAC PDUs received from the previous hop. The station then regenerates the tunnel data unit. If the station detects the loss of any fragment, then all of the fragments that belong to the same tunnel data unit are discarded until a new first fragment is detected or a non-fragmented tunnel data unit is detected.

After the tunnel data unit is successfully regenerated, the egress station can parse the tunnel data unit, and recover the IEEE 802.16 MAC PDUs in the tunnel data unit based upon the generic MAC header (GMH) of each such IEEE 802.16 MAC PDU. The egress station passes the recovered IEEE 802.16 MAC PDUs to the upper layer of the protocol stack for further processing, e.g., ARQ in the IEEE 802.16 standard common part sub layer (CPS) layer, if the egress station is an MR-BS. If the egress station is an access RS, then it forwards the IEEE 802.16 MAC PDUs to the associated MS.

A timer starts after the egress station detects a new first fragment. If the timer expires before the egress station receives all the needed fragments to successfully reassemble the original tunnel data unit, then the egress station discard all the fragments belonging to this tunnel data unit, regardless of whether each such fragment has been successfully received or not.

Operation of Multi-Hop Approach at an Egress Station

In multi-hop approach, the egress station performs similar operations as for the egress station in the per-hop approach described above.

The timer starts after the egress station detects a new first fragment. Unlike per-hop approach, however, the timer is only maintained at the egress station, instead of at each intermediate RS and egress station.

The method described above can be applied for both centralized and distributed security mode, because the method does not require the ingress station to perform any additional operation, other than concatenating the received IEEE 802.16 MAC PDUs into the tunnel data unit. For the ingress station to decide the number of IEEE 802.16 MAC PDUs that are concatenated into one tunnel data unit, it determines the length of each 802.16 MAC PDU from the generic MAC header (GMH) of each IEEE 802.16 standard MAC PDU.

It is to be understood that various other adaptations and modifications can be made within the spirit and scope of the invention. Therefore, it is the object of the appended claims to cover all such variations and modifications as come within the true spirit and scope of the invention.

We claim:

1. A method for communicating packets in a wireless multi-hop relay network, in which the relay network includes a set of mobile stations, a set of relay stations, and a base station, wherein a particular relay station is an access relay station if the particular relay station is directly connected to a particular mobile station, comprising:
establishing a tunnel between the access station and a base station, wherein the access station is an ingress station for the tunnel and the ingress station communicates with the set of mobile station and is at a first end of the tunnel, and an egress station communicates with the base station and is a last station at a second end of the tunnel;
constructing a tunnel data unit from one or more media access control protocol data units (MPDUs) at the ingress station;
transmitting the tunnel data unit from the ingress station to the egress station; and
reconstructing the one or more MPDUs at the egress station.

2. The method of claim 1, wherein the ingress station is the access station on an uplink, and the base station is the egress station.

3. The method of claim 1, wherein the ingress station is the base station on a downlink uplink, and the access station is the egress station.

4. The method of claim 1, wherein tunnel aggregates multiple different individual connections between the set of mobile stations and the base station.

5. The method of claim 1, wherein the tunnel passes through an intermediate relay station, and the intermediate relay station reconfigures the tunnel data unit.

6. The method of claim 1, wherein the tunnel data unit includes one or more MPDUs, each of which contains a generic media access control header, optional extended subheaders, optional subheaders, a payload and an optional cyclical redundancy check.

7. The method of claim 1, further comprising:
partitioning the tunnel data unit into logical blocks at the ingress station; and
assigning a logical sequence number to each block.

8. The method of claim 7, wherein a single logical block extends across two consecutive MPDUs.

9. The method of claim 7, further comprising:
fragmenting the tunnel data unit at the ingress station or an intermediate relay station to produce multiple MPDUS, wherein fragmenting is applied between boundaries of the tunnel data unit or between boundaries of the blocks.

10. The method of claim 7, further comprising:
negotiating a size of the blocks between the ingress station and the egress station for the tunnel data units.

11. The method of claim 7, wherein the logical sequence number is fourteen bits.

12. The method of claim 14-bit block sequence number.

13. The method of claim 6, wherein the subheaders include a fragmentation subheader, and further comprising:
partitioning the one or more MPDUs into logical blocks;
assigning a logical sequence number to each block; and
storing the sequence number of the first block in the tunnel data unit in the fragmentation subheader.

14. The method of claim 1, further comprising:
packing multiple tunnel data units to generate the one or more MPDUs at the ingress station.

15. The method of claim 1, further comprising:
packing one or more tunnel data units with a fragment of another tunnel data unit to generate one MPDU at the ingress station or an intermediate relay station.

16. The method of claim 1, further comprising:
packing two fragments of two different tunnel data units to generate one MPDU at the ingress station or an intermediate relay station.

17. The method of claim 1, further comprising:
inserting fragmentation subheader in front of a fragment of the tunnel data unit when constructing the MPDU without packing.

18 The method of claim 1, further comprising:
inserting a packing subheader in front of a fragment of the tunnel data unit when constructing the one or more MPDUs with packing.

19 The method of claim 1, further comprising:
inserting packing subheader in front of a tunnel data unit when creating the relay MAC PDU with packing.
